(19) United States
(12) Patent Application Publication
(10) Pub. No.: US 2002/0045024 A1
(43) Pub. Date: Apr. 18, 2002

(54) Palletizing sheets with vacuum breaking perforations

(76) Inventor: Randall C. Wise, Lititz, PA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/960,186

(22) Filed: Sep. 21, 2001

Related U.S. Application Data
(60) Provisional application No. 60/234,729, filed on Sep. 22, 2000.

(51) Int. Cl. B32B 3/10

(52) U.S. Cl. 428/131; 156/252

(57) ABSTRACT

A perforated palletizing sheet 10 and method for forming such palletizing sheets 10 for receiving, handling, storing and shipping unitized loads. The method includes placing at least one perforation 18 in a upper surface 14 of the palletizing sheet 10. The size, shape, number, and placement of perforations 18 acting to prevent formation of a vacuum between adjacent sheets such that when an attempt is made to transfer the top palletizing sheet 10 from a stack thereof, only the top sheet is transferred.

### CROSS-REFERENCE TO RELATED APPLICATION

This application claims priority to copending U.S. provisional application entitled, “Fibreboard Sheets With Vacuum Breaking Perforations,” having Ser. No. 60/234,729, filed Sep. 22, 2000, which is incorporated herein by reference.

### FIELD OF THE INVENTION

The invention relates to palletizing sheets for receiving, handling, storing and shipping a unitized load product and, more particularly, to an improved palletizing sheet for use in automated palletizing systems.

### BACKGROUND OF THE INVENTION

In many applications, product, e.g., cartoned or bagged product, is unitized to achieve economies by receiving, shipping, handling and storing the product in bulk loads. For many years, these unitized loads were carried on conventional hard wood pallets. The wooden pallet system for handling unitized loads was adopted and became the most popular system initially because the wood pallet was low in cost, availability of wood was adequate, and it was easy to handle the product on the wooden pallet with a standard forklift truck. However, the use of wooden pallets has suffered from a number of disadvantages. These include high initial investment cost, problems in inventorying and storage, high cost of pallet maintenance to keep the pallets in service, high cost of pallet replacement, problems of lost pallets, and high weight and volume which add significant cost to shipment and space requirements for storage of the pallets. Because wooden pallets are rather bulky and require large amounts of space for storage, they are often stored in the outside environment between uses. As such, they are susceptible to the elements and infestation by both rodents and insects, which can ultimately lead to infestation of the products to be palletized. As well, wooden pallets can also cause damage to the load during handling and storage, for example, by nails and broken boards rupturing packages mounted on the pallets.

For these and other various reasons, the palletizing sheet method of handling unitized loads was adopted and its use has continued to expand up to the present day. A palletizing sheet is a thin sheet of material that is of a length and width generally the size of the unit load. Various constructions of palletizing sheets perform different functions within the palletizing process. For example, there are those palletizing sheets upon which an entire unitized load is placed, and there are those sheets that are placed between the various layers of a given load. The former are often referred to as slipsheets, and the latter as tiersheets. Slipsheets typically have one or more “pull tabs” which extend about three or four inches beyond the load, allowing the slipsheet to be gripped and pulled onto the platens of a forklift truck with the aid of a gripper or push-pull attachment mounted to the forklift truck. Typically, the slipsheets are provided with pull tabs on adjacent sides allowing the load to be picked up either from the front or the side for convenience of loading and full utilization of trailer width. However, they can be made with any number of tabs. Tiersheets, on the other hand, typically do not require pull tabs because they are placed between the various layers of a load.

In the palletizing or unitizing process, a stack of palletizing sheets is typically provided for use in assembling multiple loads. The sheets are sequentially picked up and transferred one by one to a loading area, and the load unitized on the palletizing sheet for shipment. Typically, the top palletizing sheet of the stack is removed from the stack and transferred to the loading area by means of a suction gripping apparatus. This is a device that includes one or more gripping heads to which suction is applied. The suction causes the gripping heads to grip the upper surface of the top palletizing sheet. The gripper with attached palletizing sheet is then transferred to the loading and/or palletizing area where the suction is released, in turn releasing the palletizing sheet. The gripper is then moved back to the stack of palletizing sheets to grip the sheet now at the top of the stack, and the process is repeated. The load to be palletized is placed on the palletizing sheet, which has been transferred, and that load is secured such as by stretch wrapping. As noted above, the palletizing sheet underlying the entire load is the slipsheet, and tiersheets may or may not be used within the load to separate various layers. The palletized load, along with its underlying slipsheet, is then transferred to a storage or transport area. Once this load is removed, the next palletizing sheet is gripped by the transfer apparatus and transferred to the loading and/or palletizing area. This transfer process from the stack of palletizing sheets to the loading area continues until the stack is exhausted.

A major problem that has been observed with this method of transferring palletizing sheets is that, often, a vacuum exists between the top palletizing sheet and subsequent sheets. Consequently, the vacuum may cause one or more sheets, in addition to the top palletizing sheet, to be transferred to the palletizing area at the same time. Generally, this problem occurs in palletizing sheets having a thickness on the order of between 0.02 inch to 0.120 inch. As a result, there exists a significant problem in handling and transporting palletizing sheets using the suction gripping method of transfer.

Prior art attempts to solve this problem have included embossing or lightly dusting the surfaces of the palletizing sheets in an effort to allow airflow between adjacent sheets. Although such methods have reduced the problem of multiple palletizing sheet pick-ups, they have not eliminated the problem.

### SUMMARY OF THE INVENTION

The problem of multiple palletizing sheet transfer described above is overcome without the use of embossing rollers or the added processing step of applying fine dust to the boards. In accordance with the present invention, the palletizing sheets are provided with at least one perforation that extends from the upper surface to the lower surface of each palletizing sheet. The perforations are such that when the palletizing sheets are stacked upon one another, the perforations form an airflow passage between the upper surface of the top palletizing sheet and the bottom surface of the top sheet, which is in contact with the upper surface of the adjacent palletizing sheet. By so providing, any potential vacuum existing between adjacent palletizing sheets during suction transfer will be negated and the transfer of individual palletizing sheets, one at a time, will be possible. The perforations are normally placed on the palletizing sheet such that it will not be within the area on the palletizing sheet contacted by the suction gripper apparatus.

Palletizing sheet formation is well known in the prior art. Numerous means may be adequate for forming the perforations required in the present invention. However, a preferred embodiment of the present invention would include palletizing sheets which are cut to the desired size. After the palletizing sheet is the desired size, the desired number of perforations would be die cut at the necessary locations and in the necessary shapes and sizes.

These and other objects and advantages of the details of construction will become apparent upon reading the following description of the illustrative embodiment describing the principles of the present invention with reference to the attached drawings wherein like reference numerals have been used to refer to like parts throughout the several figures.

### BRIEF DESCRIPTION OF THE DRAWINGS

FIGS. 1A-1F are top views of palletizing sheets of the present invention showing various embodiments of perforation shape, number and location.

FIG. 2 is a flow chart depicting the process of using palletizing sheets of the present invention in the palletizing/unitizing process.

FIG. 3 is a top view of the palletizing sheet as shown in FIG. 1A, showing various placements of a suction gripper apparatus.

FIG. 4 is a partial side view of the palletizing sheet as shown in FIG. 1F, along line IV-IV.

FIG. 5 is a flow chart depicting a process of producing palletizing sheets of the present invention.

### DETAILED DESCRIPTION

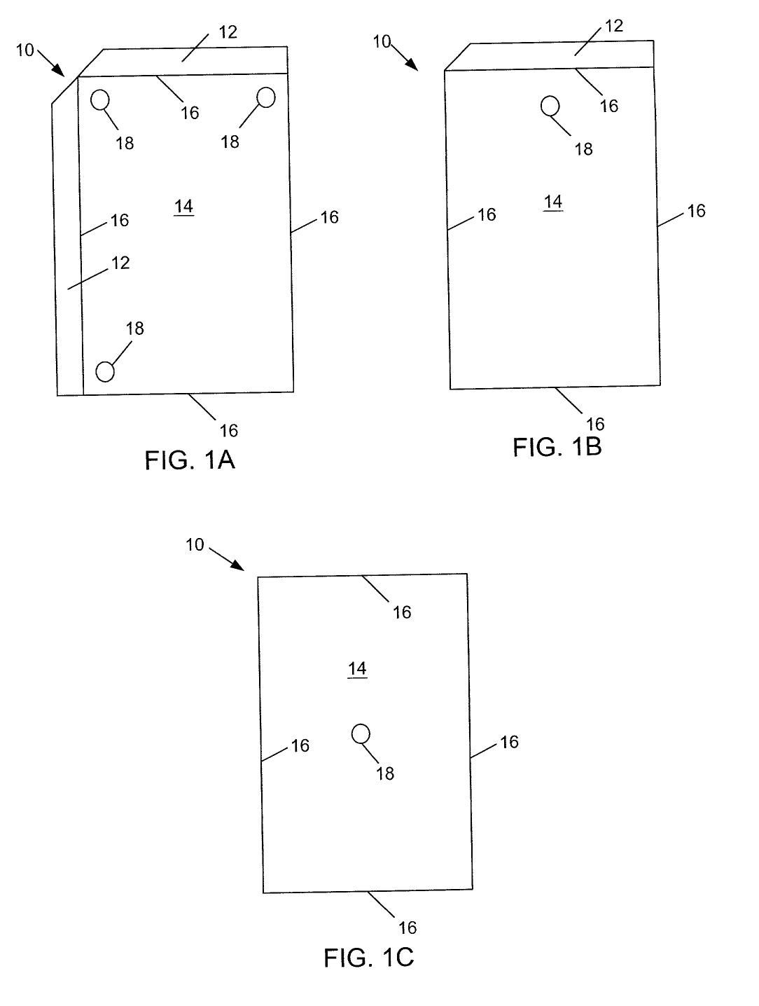

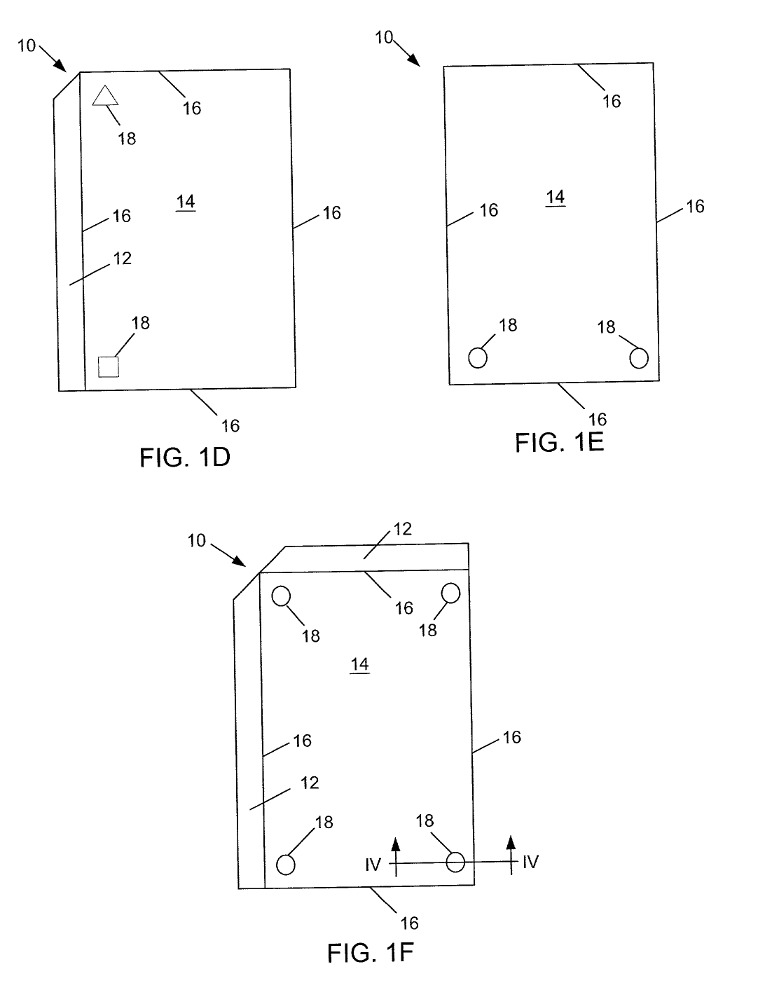

Referring now to FIGS. 1A-1F, in the automated palletizing process, a load which is unitized, for example, by taping, tying, gluing, cartoning or stretch wrapping, has a defined unit width and length. A palletizing sheet 10 is the medium upon which the unit load is placed, and is sized in accordance with the size of the load to be placed thereon. Palletizing sheets 10 are often placed between the various layers of the unit load. The underlying palletizing sheet 10 (commonly referred to as a slipsheet) typically has two pull tabs 12, generally three to four inches in width, on adjacent sides of the palletizing sheet upper surface 14 (defined by edges 16) which facilitate transferring the unitized load once it has been placed on the palletizing sheet 10. However, any shape or number of tabs 12 may be used, and may be configured about the edges 16 of the palletizing sheet 10 as desired. An indentation is often provided consistent with the edge 16 along which a pull tab 12 is attached. Although not necessary, the indentation permits the pull tab 12 to be more readily deflected, thereby allowing a gripper apparatus on a forklift (not shown) to more easily grasp the pull tab. Also, in that the pull tab 12 is more easily deflected, it is less likely to puncture and damage adjacent goods than is a pull tab without the capability to deflect. Those palletizing sheets 10 that are placed between various layers of the unit load (commonly referred to as tiersheets) typically have no pull tabs 12.

Note that any number of perforations 18 can be used, and that the location of those perforations can also be varied as desired. Any shape (circular, triangular, square, irregular, etc.) can be used for the perforation 18 so long as adequate airflow is allowed therethrough, thereby negating any potential vacuum that may exist between adjacent palletizing sheets 10 during transfer of the top palletizing sheet 10. Although various shapes, sizes, numbers and locations, of perforations 18 are within the scope of the present invention, in the preferred embodiment represented in FIG. 1A, the palletizing sheet upper surface 14 has three perforations 18, one being distributed in each of three comers. In the preferred embodiment, predominantly circular perforations 18, approximately 0.250 inches in diameter, have been found to perform satisfactorily. Note, however, that the required size of the perforations 18 can vary greatly depending on the number of perforations used, as well as the thickness of the palletizing sheet 10 and the material used in its construction. For example, perforations 18 with diameters ranging from 0.1 inch to 3.0 inches have been found to function adequately without jeopardizing the structural integrity of the palletizing sheets 10. Although the perforations 18 may be formed at any location on the upper surface 14 of the palletizing sheet, placement in the comers approximately three inches from adjacent edges 16 of the upper surface has been found to perform satisfactorily.

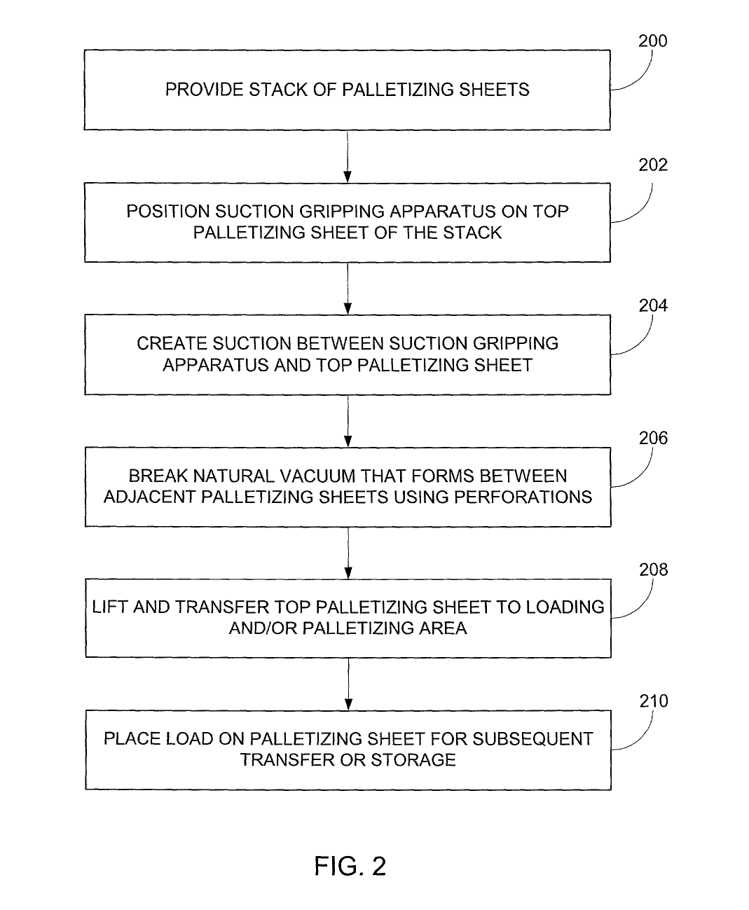

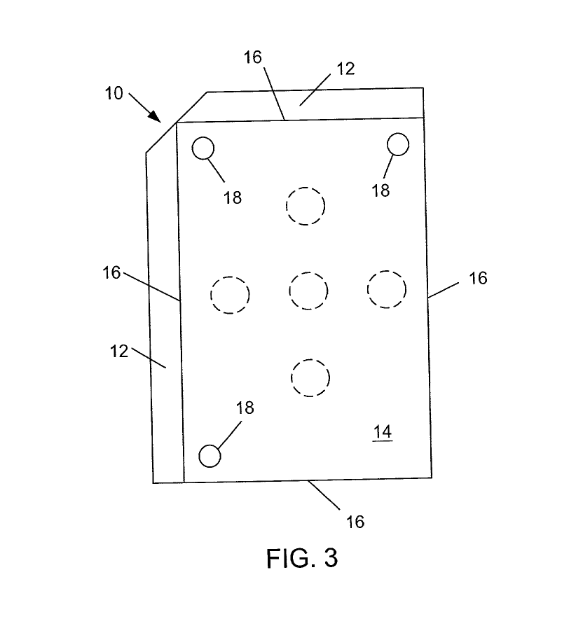

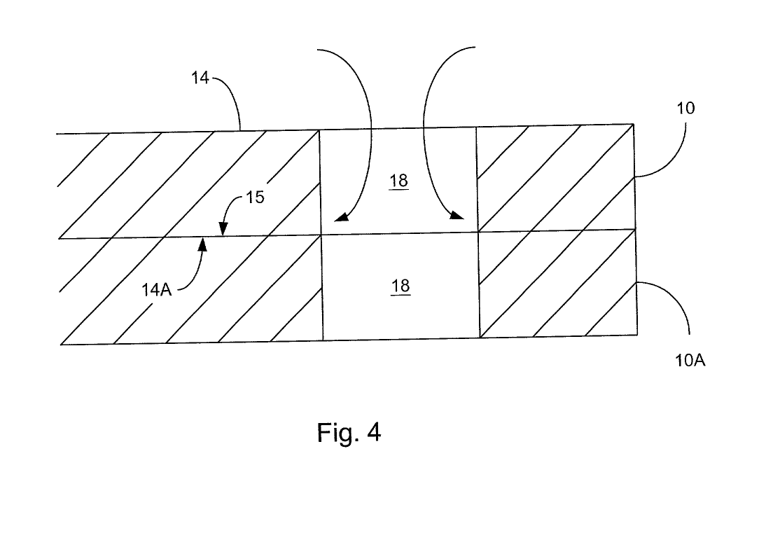

The palletizing or unitizing process is depicted in FIG. 2. First, as shown in block 200, a stack of palletizing sheets 10 is provided. Typically, the palletizing sheets 10 of the stack are picked up and transferred to a loading station, one at a time. The top palletizing sheet 10 of the stack is picked up and transferred to the loading area by a suction gripping apparatus, (not shown) as is well known in the art. The suction gripping apparatus typically has one or more gripping heads. As described in block 202, the suction heads are normally positioned on the upper surface 14 of the top palletizing sheet 10, such that the gripper heads do not encompass any of the perforations 18. FIG. 3 shows the palletizing sheet 10 of FIG. 1A with potential placements of the gripper head (not shown) depicted as broken circles. Next, the gripper head is used to create a suction, thereby “gripping” the top palletizing sheet 10, as described in block 204. This is the point at which prior art systems experience problems. Because of the tendency for a natural vacuum to form between the top palletizing sheet 10 and those subsequent palletizing sheets 10 in the stack, the simultaneous transfer of multiple palletizing sheets 10 often occurs with prior art systems.

As previously noted, perforations 18 are used to overcome this problem by “breaking” the natural vacuum that may develop between adjacent palletizing sheets 10, as described in block 206. As shown in FIG. 4, as the top palletizing sheet 10 is lifted from the stack, air passes through the perforations 18 (as depicted by the arrows) and between the bottom surface 15 of the top palletizing sheet 10 and the upper surface 14A of the adjacent palletizing sheet 10A, thereby preventing the formation of a natural vacuum. As such, only the top palletizing sheet 10 will be lifted and transferred to the loading and/or palletizing area, as described in block 208. Once in the loading and/or palletizing area, the suction is released, in turn releasing the palletizing sheet 10. As described in block 210, once a load is placed on the palletizing sheet 10, the load and associated palletizing sheet 10 are removed to a storage or transport area. Again, palletizing sheets 10 may also be used between various layers of the load when desired.

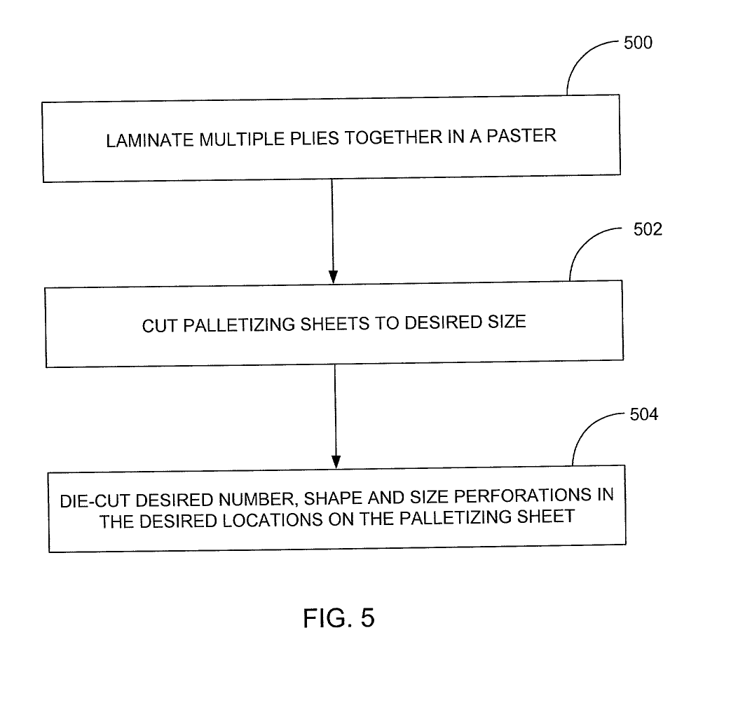

Although numerous materials can be used to produce the palletizing sheets 10 of the present invention (i.e., plastic, nylon, polymers, fibreboard, chipboard), the preferred embodiment includes laminating multiple plies of paperboard material, such as kraft paper. One method of manufacturing palletizing sheets 10 in accordance with the present invention is described in FIG. 5. First, as described in block 500, multiple plies are laminated together, as in a paster. Next, as described in block 502, the palletizing sheets 10 are cut to the desired size. Frequently, this is dictated by factors such as load size, load weight, or space available in a transport vehicle or storage facility. Finally, as described in block 504, the desired number and shape of perforations 18 are created in the palletizing sheets 10 at the desired locations. In the preferred embodiment, the perforations are die-cut; however, other methods or means of providing the perforation or perforations can be employed to produce the same result and are considered to be within the scope of the present invention. In its simplest form, the perforation or perforations could be cut by hand. Single ply or multi-ply palletizing sheets 10 are encompassed within the scope of the present invention. Whether single ply or multi-ply sheets are required will depend on factors such as the material, dimensions and weight of load, etc.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A palletizing sheet for use with a suction gripper apparatus, comprising:
an upper surface for receiving goods and a bottom surface, said upper surface and said bottom surface being defined by a plurality of edges;
at least one perforation formed in said palletizing sheet such that an airflow passage is formed between said upper surface and said bottom surface; and
wherein said airflow passage prevents formation of a vacuum between said palletizing sheet and an adjacent palletizing sheet during suction transfer of said palletizing sheet with the suction gripper apparatus.

2. A method of producing palletizing sheets, comprising the steps of:
cutting a sheet of material to a desired size; and
forming one or more perforations in said sheet of material.

3. The method of claim 2, wherein said sheet of material further comprises one of: kraft paper, paperboard, chipboard, fibreboard, plastic, nylon, or polymer.

4. A method of transferring a palletizing sheet using a suction gripper apparatus, comprising the steps of:
providing a stack of palletizing sheets, wherein each of said stack of palletizing sheets includes at least one perforation;
placing the suction gripper apparatus in contact with a top palletizing sheet of said stack such that said at least one perforation is not within an area of said top palletizing sheet contacted by the suction gripper apparatus;
producing a suction force on said top palletizing sheet with the suction gripper apparatus;
using said suction force to separate said top palletizing sheet from said stack; and
wherein said at least one perforation prevents the formation of a vacuum between said top palletizing sheet and a subsequent palletizing sheet by allowing airflow therethrough.
